(19) United States
(12) Patent Application Publication
(10) Pub. No.: US 2025/0153795 A1
(43) Pub. Date: May 15, 2025

(54) BICYCLE PASSENGER LINER

(71) Applicant: The Radio Flyer Company, Chicago, IL (US)

(72) Inventors: Agostino LoBello, Chicago, IL (US); Igor Zemskov, Chicago, IL (US)

(21) Appl. No.: 18/947,532

(22) Filed: Nov. 14, 2024

Related U.S. Application Data
(60) Provisional application No. 63/599,162, filed on Nov. 15, 2023.

(51) Int. Cl. B62J 9/23; B62J 1/20; B62J 9/24

(52) U.S. Cl. CPC B62J 9/23; B62J 1/20; B62J 9/24

(57) ABSTRACT

A passenger liner for a cargo frame connected to a bicycle frame. The passenger liner has a front wall, a rear wall, a first foot well extending between the front wall and the rear wall, a second foot well extending between the front wall and the rear wall, and a connection member connecting the first foot well with the second foot well. At least one of the first foot well or the second foot well has an exterior side wall that is removably connected to the respective foot well. Additionally, the connection member may be disconnected from at least one of the first foot well or the second foot well.

### CROSS-REFERENCE TO RELATED APPLICATIONS

This application claims the benefit of U.S. Provisional Patent Application No. 63/599,162 filed Nov. 15, 2023, which is expressly incorporated herein by reference and made a part hereof.

### FEDERALLY SPONSORED RESEARCH OR DEVELOPMENT

Not Applicable.

### TECHNICAL FIELD

The present subject matter relates to a passenger liner for a bicycle, and more particularly, to a passenger liner that is removable from the bicycle and that has multiple quick access locations.

### BACKGROUND

Passenger liners for bicycles are known in the art. While such products, according to the prior art, provide a number of advantages, they nevertheless have certain limitations. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to a passenger liner for a bicycle, and more particularly, to a passenger liner that is removable from the bicycle and that has multiple quick access locations.

The disclosed technology further relates to a passenger liner for a cargo frame connected to a bicycle frame, the passenger liner comprising: a front wall; a rear wall; a first foot well having a first exterior side wall, a first interior side wall, and a first bottom wall joining the first exterior side wall and the first interior side wall, the first interior side wall having a first end connected to the front wall, the first interior side wall having a second end connected to the rear wall, and wherein the first exterior side wall is removably connected to the first foot well; a second foot well having a second exterior side wall, a second interior side wall, and a second bottom wall joining the second exterior side wall and the second interior side wall, the second interior side wall having a first end connected to the front wall, and the second interior side wall having a second end connected to the rear wall, and wherein the second exterior side wall is removably connected to the second foot well; a connection member connecting the first interior side wall of the first foot well to the second interior side wall of the second foot well, wherein the connection member can be disconnected from at least one of the first interior side wall and the second interior side wall; and, fasteners provide adjacent each of the front wall, rear wall, first exterior side wall and second exterior side wall, to secure the passenger liner to the cargo frame.

The disclosed technology further relates to a passenger liner for a cargo frame connected to a bicycle frame, the passenger liner comprising: a front wall; a rear wall; a first foot well extending between the front wall and the rear wall, the first foot well having a first exterior side wall that is removably connected to the first foot well; a second foot well extending between the front wall and the rear wall, the second foot well having a second exterior side wall that is removably connected to the second foot well; a connection member connecting the first foot well with the second foot well; and, fasteners to secure the passenger liner to the cargo frame.

The disclosed technology further relates to a passenger liner for a cargo frame connected to a bicycle frame, the passenger liner comprising: a front wall; a rear wall; a first foot well having a first exterior side wall, a first interior side wall, and a first bottom wall between the first exterior side wall and the first interior side wall, the first interior side wall having a first end connected to the front wall, the first interior side wall having a second end connected to the rear wall, and wherein the first exterior side wall is removably connected to the first foot well; a second foot well having a second exterior side wall, a second interior side wall, and a second bottom wall between the second exterior side wall and the second interior side wall, the second interior side wall having a first end connected to the front wall, and the second interior side wall having a second end connected to the rear wall; a connection member connecting the first interior side wall of the first foot well with the second interior side wall of the second foot well; and, fasteners to secure the passenger liner to the cargo frame.

The disclosed technology further relates to a passenger liner, wherein the first exterior side wall, first interior side wall and first bottom wall of the first foot well defines a first cavity, and wherein the second exterior side wall, second interior side wall and second bottom wall of the second foot well defines a second cavity.

The disclosed technology further relates to a passenger liner, wherein the passenger liner is removably secured to the cargo frame.

The disclosed technology further relates to a passenger liner, wherein the connection member is removably secured to each of the first interior side wall and the second interior side wall with a zipper.

The disclosed technology further relates to a passenger liner, wherein the first exterior side wall has a top, a bottom and opposing sides, wherein the second exterior side wall has a top, a bottom and opposing sides, and wherein the opposing sides and bottom of the first exterior side wall are removably connected to the first foot well with disconnecting members.

The disclosed technology further relates to a passenger liner, wherein the disconnecting members are zippers.

The disclosed technology further relates to a passenger liner, wherein the opposing sides and bottom of the second exterior side wall are removably connected to the second foot well with disconnecting members.

The disclosed technology further relates to a passenger liner, further comprising a generally flat seat secured to one of the bicycle frame and the cargo frame.

The disclosed technology further relates to a passenger liner, wherein the liner is made of a fabric material.

The disclosed technology further relates to a passenger liner, further comprising an extension extending from the rear wall, the extension extending over a top of a rear frame member of the cargo frame and being secured around the rear frame member with fasteners.

The disclosed technology further relates to a passenger liner, further comprising an extension extending from the front wall, the extension extending over a top of a front frame member of the cargo frame and being secured around the front frame member with fasteners.

The disclosed technology further relates to a passenger liner, further comprising a cover provided over the cargo frame and passenger liner, the cover having elastic about a perimeter to secure the cover around the passenger liner and close off a top opening to the passenger liner.

The disclosed technology further relates to a passenger liner, further comprising a fastener securing the first foot well to the bicycle frame, and a fastener securing the second foot well to the bicycle frame.

The disclosed technology further relates to a passenger liner, wherein the first foot well also has a first interior side wall and a first bottom wall joining the first exterior side wall to the first interior side wall, wherein the first interior side wall has a first end connected to the front wall and a second end connected to the rear wall, wherein the second foot well also has a second interior side wall and a second bottom wall joining the second exterior side wall to the second interior side wall, wherein the second interior side wall has a first end connected to the front wall and a second end connected to the rear wall.

The disclosed technology further relates to a passenger liner, wherein the connection member is removably connected to at least one of the first interior side wall and the second interior side wall.

The disclosed technology further relates to a passenger liner, wherein the first exterior side wall has a top, a bottom and opposing sides, wherein the second exterior side wall has a top, a bottom and opposing sides, and wherein the opposing sides and bottom of the first exterior side wall are removably connected to the first foot well with disconnecting members.

The disclosed technology further relates to a passenger liner, wherein the second exterior side wall is removably connected to the second foot well.

The disclosed technology further relates to a passenger liner, wherein the connection member can be disconnected from at least one of the first interior side wall and the second interior side wall.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a perspective view of a cargo holder for a bicycle, according to the present disclosure.

FIG. 2 is a perspective view of a passenger liner connected to the cargo holder of FIG. 1, according to the present disclosure.

FIG. 3 is a rear perspective view of the passenger liner and cargo holder of FIG. 2, according to the present disclosure.

FIG. 4 is a top-side perspective view of the passenger liner and cargo holder of FIG. 2, according to the present disclosure.

FIG. 5 is a front perspective view of the passenger liner and cargo holder of FIG. 2, according to the present disclosure.

FIG. 6 is a top view of the passenger liner and cargo holder of FIG. 2, according to the present disclosure.

FIG. 7 is an internal view of the passenger liner and cargo holder of FIG. 2, according to the present disclosure.

FIG. 8 is a bottom-side perspective view of the passenger liner and cargo holder of FIG. 2, according to the present disclosure.

FIG. 9 is a side perspective view of the passenger liner and cargo holder of FIG. 2, illustrating the opening capabilities of the liner, according to the present disclosure.

FIG. 10 is a side perspective view of the passenger liner and cargo holder of FIG. 2, illustrating the opening capabilities of the liner, according to the present disclosure.

FIG. 11 is a perspective view of the passenger liner and cargo holder of FIG. 2, with a cover over the liner, according to the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

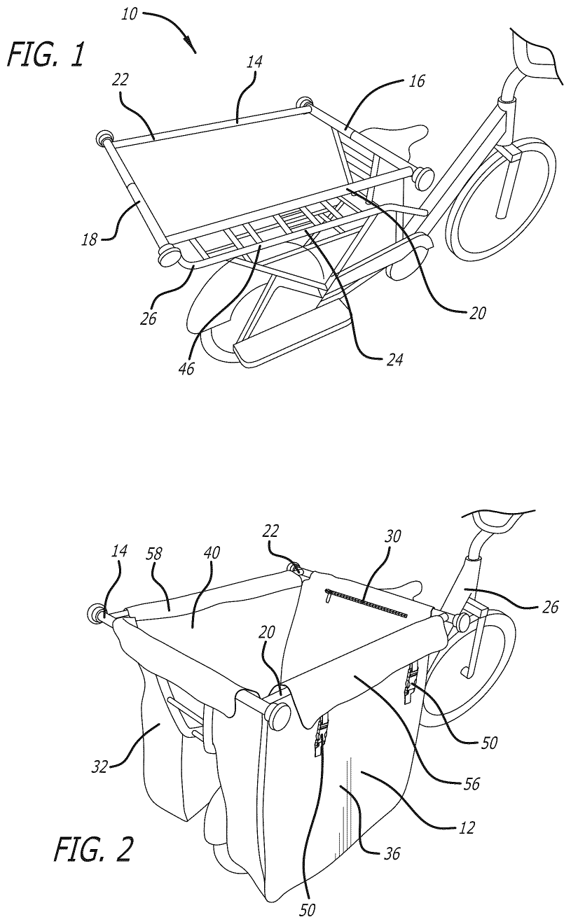

Generally, this disclosure describes several embodiments of passenger liners for bicycles, and preferably passenger liners that can be removably inserted into cargo holders for bicycles, liners that have easy access for the passengers to get in and out of the liner, and liners that are arrangeable in a variety of different orientations. Typically, as shown in FIG. 1, the cargo holder 10 is utilized with bicycles, including e-bikes, and is connected to the frame of the bicycle. The cargo holder 10 may be operable in at least two modes, a storage mode and a passenger transport mode, and can accept a variety of accessories. Additionally, as shown in FIG. 2, a passenger liner 12 may be added to the cargo holder 10.

Referring now to the figures, and initially to FIG. 1, there is shown an embodiment of a cargo holder 10 for carrying cargo or passengers. In one embodiment, the cargo holder 10 generally comprises a frame 14 that is secured to a bicycle frame 26. And, in one embodiment the frame 14 comprises a first frame end 16, a second frame end 18, a first side frame 20, a second side frame 22, and a frame bottom 24. In one embodiment, the frame bottom 24 can be a portion of the bicycle frame 26. In one embodiment, the first frame end 16 has structure to connect to the frame bottom 24, and the second frame end 18 also has structure to connect to the frame bottom 24. In one embodiment, the cargo holder 10 is secured to the bicycle frame 26 behind the bicycle seat. In one embodiment, the frame 14 of the cargo holder 10 is made of tubular aluminum material, although other materials such as metal, plastic, wood, etc., whether in tubular, solid, square, etc. form will work as the frame 14. Additionally, in one embodiment the cargo holder 10 is rectangular in shape, however, it may be any other shape acceptable to provide the desired function, such as trapezoidal, square, round or another shape.

As best shown in FIGS. 2-5, the liner 12 is removably secured to the cargo holder 10. In one embodiment, the liner 12 may comprise a housing having a front wall 30, a rear wall 32, a first foot well 34 having a first exterior side wall 36, a second foot well 38 having a second exterior side wall 40, and a connection member 42 connecting the first foot well 34 and the second foot well 38. In a preferred embodiment, the first exterior side wall 36 is removably connected to the first foot well 34, and the second exterior side wall 40 is removably connected to the second foot well 38. The various walls and foot wells define a cavity 44 therebetween. In one embodiment the first foot well 34 also has a first interior side wall 60, and a first bottom wall 66 joining the first exterior side wall 36 and the first interior side wall 60. Similarly, in one embodiment the second foot well 38 has a second exterior side wall 40, a second interior side wall 62, and a second bottom wall 66 joining the second exterior side wall 40 and the second interior side wall 62. Further, in one embodiment the first interior side wall has a first end connected to the front wall 30 and a second end connected to the rear wall 32, and the second interior side wall 62 has a first end connected to the front wall 30 and a second end connected to the rear wall 32.

In one embodiment, a generally flat seat (not shown) may be secured to one or both of the frame 14 of the cargo holder 10 or the bicycle frame 26. In one embodiment, the seat may have a cushion component and a securing device. The seat may rest on the top surface of the cargo portion 46 of the bicycle frame 26. In one embodiment, the securing device for the seat comprises one or more straps to secure the seat to the bicycle frame 26. Accordingly, the seat may be attached and removed from the cargo holder 10 quickly and easily.

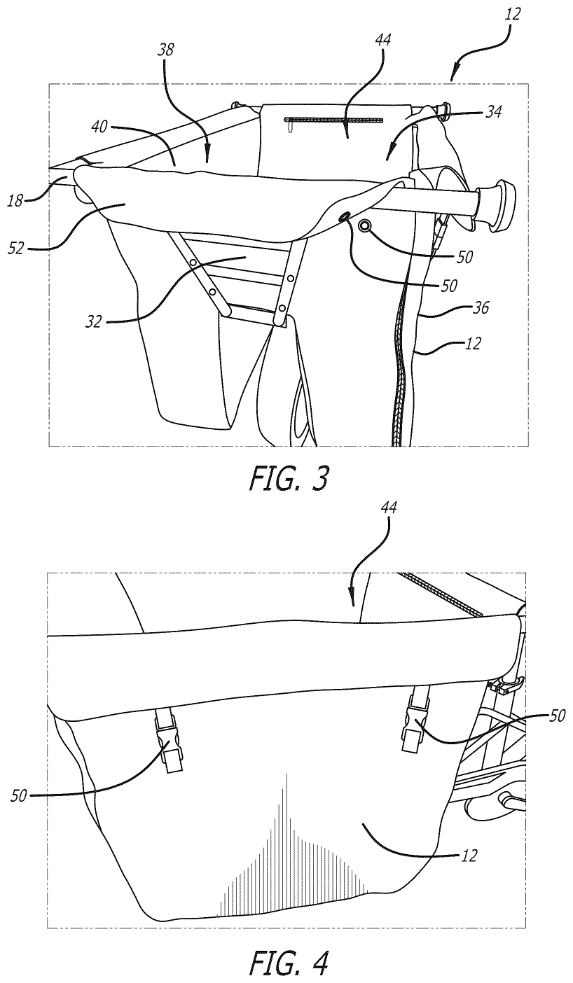

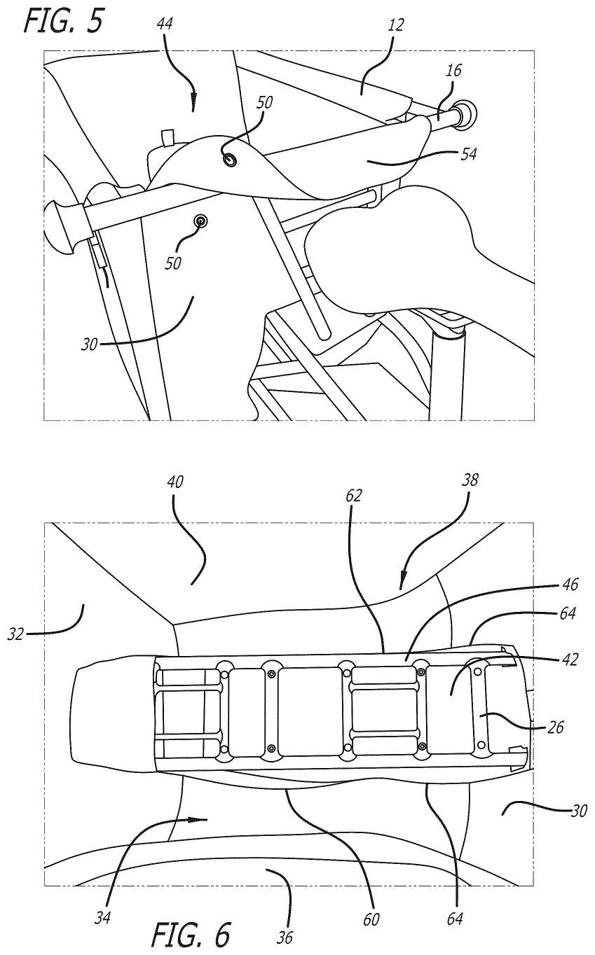

In one embodiment, the liner 12 is soft sided and made of a fabric material. The cavity 44 of the liner 12 is preferably provided for passengers. The liner 12 is removably secured to one or more of the bicycle frame 26 or frame 14 of the cargo holder 10 via a variety of fasteners. In one embodiment, fasteners are provide adjacent each of the front wall 30, rear wall 32, first exterior side wall 36 and second exterior side wall 40. As shown in FIG. 3, in one embodiment fasteners 50, such as buttons, snaps or Velcro fasteners are used to secure the rear wall 32 to the frame 14 of the cargo holder 10 (in one embodiment by having an extension 52 of the rear wall 32 placed over the top of the second frame end 18 and then secured around the second frame end 18 to that respective end wall 32 via mating fasteners 50). Similarly, as shown in FIG. 5, in one embodiment fasteners 50, such as buttons, snaps or Velcro fasteners are used to secure the front wall 30 to the frame 14 of the cargo holder 10 (in one embodiment by having an extension 54 of the front wall 30 placed over the top of the first frame end 16 and then secured around the first frame end 16 to that respective front wall 30 via mating fasteners 50). Referring to FIGS. 2 and 4, fasteners 50 connected to the first exterior side wall 36 secure the first exterior side wall 36 to the frame 14 of the cargo holder 10 (in one embodiment by having an extension 56 of the first exterior side wall 36 placed over the top of the first side frame 20 and then secured around the first side frame 20 to that respective first exterior side wall 36 via mating fasteners 50). Similarly, fasteners 50 connected to the second exterior side wall 40 secure the second exterior side wall 40 to the frame 14 of the cargo holder 10 (in one embodiment by having an extension 58 of the second exterior side wall 40 placed over the top of the second side frame 22 and then secured around the second side frame 22 to that respective second exterior side wall 40 via mating fasteners 50). In one embodiment, as shown in FIGS. 2 and 4, at the two opposing exterior side walls, buckles or clips are the preferred fastener 50 used to secure the liner 12 to the first side frame 20 and the second side frame 22.

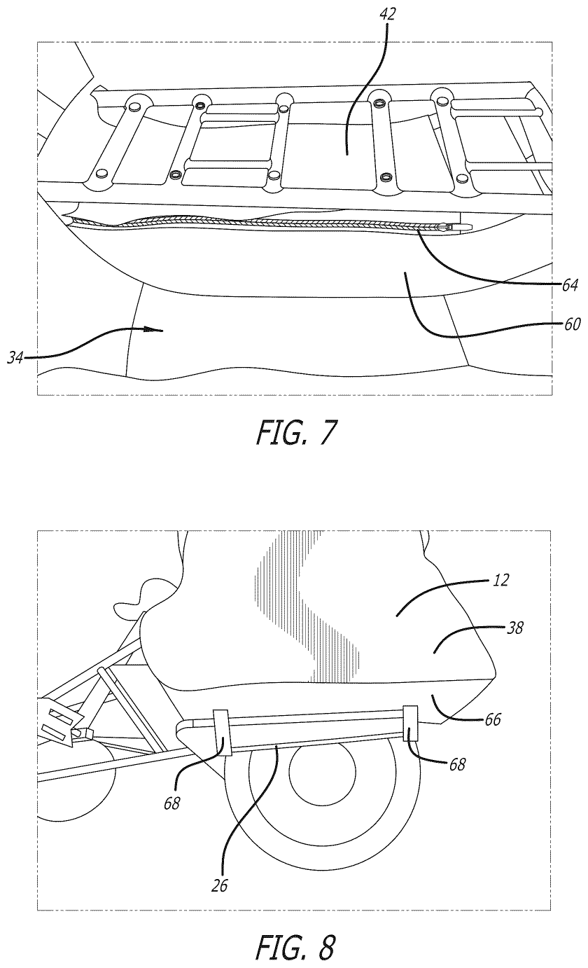

Referring to FIGS. 6 and 7, the connection member 42 connects the first foot well 34 to the second foot well 38. In order to be able to secure the liner 12 around the bicycle frame 26 and the frame 14 of the cargo holder 10, the connection member 42 is removably secured to one or both of the interior wall 60 of the first foot well 34 and the interior wall 62 of the second foot well 38. In one embodiment, a zipper 64 is used at each side of the connection member 42 to secure the connection member 42 to each of the interior wall 60 of the first foot well 34 and the interior wall 62 of the second foot well 38. One or both of the zippers 64 can be unzipped to disconnect the connection member 42 from one or both of the interior walls 60 and 62 to allow for insertion and removal of the liner 12.

As shown in FIG. 8, in one embodiment the bottom 66 of each foot well 34, 38 has fasteners 68, such as straps 68, to secure the first and second foot wells 34 and 38 to the bicycle frame 26.

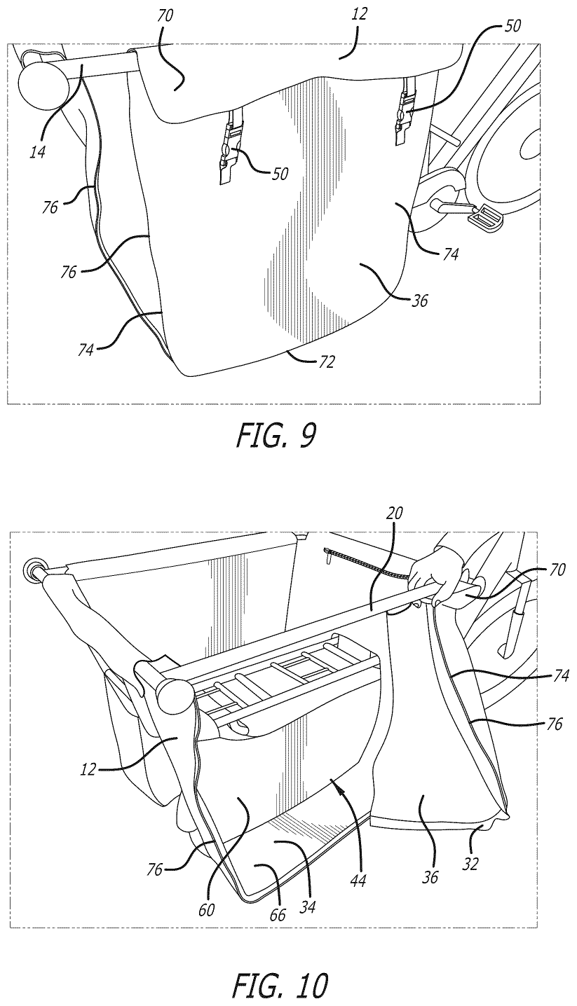

Referring to FIGS. 9 and 10, the first and second exterior side walls 36 and 40 are removably connected to the liner 12. In one embodiment, the each of the first and second exterior side walls 36 and 40 have a top 70, bottom 72 and opposing sides 74. As shown in the figures, in one embodiment, a connector 76, such as a zipper 76, connects the opposing sides, 74 and bottom 72 of each respective side wall 36 and 40 to the liner 12. Accordingly, to get in and out of the liner 12, a user merely needs to unzip a portion of the connection of one or more of the exterior side walls 36 and 40 with the liner 12, as shown in FIG. 10, and then climb into the cavity 44 of the liner 12 and re-zip the zipper 76. The top 70 of the side walls 36, 40 can slide on the respective first side frame 20 or second side frame 22 as shown in FIG. 10. Thus, the liner 12 has multiple quick access locations for entering and exiting the cavity 44 of the liner 12.

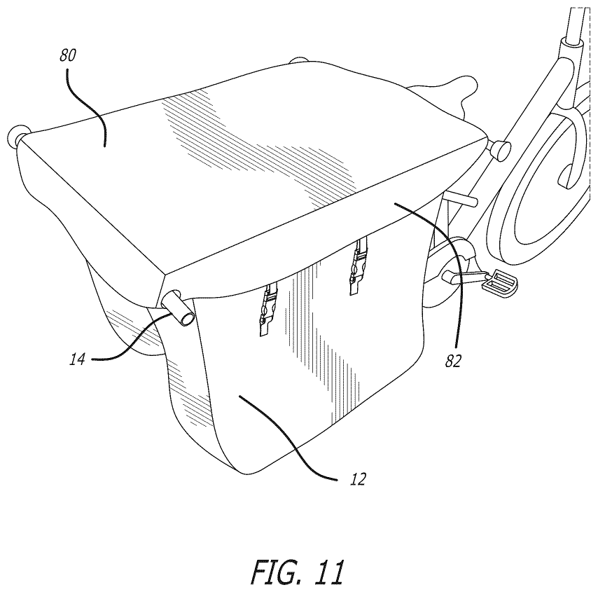

In one embodiment, as shown in FIG. 11, a cover 80 may be provided over the cargo holder 10 and liner 12. The cover 80 may have elastic about a perimeter 82 of the cover 80 to secure the cover 80 around the cargo holder 10 to close off the cavity 44 of the liner 12.

The embodiments detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A passenger liner for a cargo frame connected to a bicycle frame, the passenger liner comprising:
a front wall;
a rear wall;
a first foot well having a first exterior side wall, a first interior side wall, and a first bottom wall joining the first exterior side wall and the first interior side wall, the first interior side wall having a first end connected to the front wall, the first interior side wall having a second end connected to the rear wall, and wherein the first exterior side wall is removably connected to the first foot well;
a second foot well having a second exterior side wall, a second interior side wall, and a second bottom wall joining the second exterior side wall and the second interior side wall, the second interior side wall having a first end connected to the front wall, and the second interior side wall having a second end connected to the rear wall, and wherein the second exterior side wall is removably connected to the second foot well;
a connection member connecting the first interior side wall of the first foot well to the second interior side wall of the second foot well, wherein the connection member can be disconnected from at least one of the first interior side wall and the second interior side wall; and,
fasteners provide adjacent each of the front wall, rear wall, first exterior side wall and second exterior side wall, to secure the passenger liner to the cargo frame.

2. The passenger liner of claim 1, wherein the first exterior side wall, first interior side wall and first bottom wall of the first foot well defines a first cavity, and wherein the second exterior side wall, second interior side wall and second bottom wall of the second foot well defines a second cavity.

3. The passenger liner of claim 1, wherein the passenger liner is removably secured to the cargo frame.

4. The passenger liner of claim 1, wherein the connection member is removably secured to each of the first interior side wall and the second interior side wall with a zipper.

5. The passenger liner of claim 1, wherein the first exterior side wall has a top, a bottom and opposing sides, wherein the second exterior side wall has a top, a bottom and opposing sides, and wherein the opposing sides and bottom of the first exterior side wall are removably connected to the first foot well with disconnecting members.

6. The passenger liner of claim 5, wherein the disconnecting members are zippers.

7. The passenger liner of claim 5, wherein the opposing sides and bottom of the second exterior side wall are removably connected to the second foot well with disconnecting members.

8. The passenger liner of claim 1, further comprising a generally flat seat secured to one of the bicycle frame and the cargo frame.

9. The passenger liner of claim 1, wherein the liner is made of a fabric material.

10. The passenger liner of claim 1, further comprising an extension extending from the rear wall, the extension extending over a top of a rear frame member of the cargo frame and being secured around the rear frame member with fasteners.

11. The passenger liner of claim 10, further comprising an extension extending from the front wall, the extension extending over a top of a front frame member of the cargo frame and being secured around the front frame member with fasteners.

12. The passenger liner of claim 1, further comprising a cover provided over the cargo frame and passenger liner, the cover having elastic about a perimeter to secure the cover around the passenger liner and close off a top opening to the passenger liner.

13. The passenger liner of claim 1, further comprising a fastener securing the first foot well to the bicycle frame, and a fastener securing the second foot well to the bicycle frame.

14. A passenger liner for a cargo frame connected to a bicycle frame, the passenger liner comprising:
a front wall;
a rear wall;
a first foot well extending between the front wall and the rear wall, the first foot well having a first exterior side wall that is removably connected to the first foot well;
a second foot well extending between the front wall and the rear wall, the second foot well having a second exterior side wall that is removably connected to the second foot well;
a connection member connecting the first foot well with the second foot well; and,
fasteners to secure the passenger liner to the cargo frame.

15. The passenger liner of claim 14, wherein the first foot well also has a first interior side wall and a first bottom wall joining the first exterior side wall to the first interior side wall, wherein the first interior side wall has a first end connected to the front wall and a second end connected to the rear wall, wherein the second foot well also has a second interior side wall and a second bottom wall joining the second exterior side wall to the second interior side wall, wherein the second interior side wall has a first end connected to the front wall and a second end connected to the rear wall.

16. The passenger liner of claim 15, wherein the connection member is removably connected to at least one of the first interior side wall and the second interior side wall.

17. The passenger liner of claim 14, wherein the first exterior side wall has a top, a bottom and opposing sides, wherein the second exterior side wall has a top, a bottom and opposing sides, and wherein the opposing sides and bottom of the first exterior side wall are removably connected to the first foot well with disconnecting members.

18. A passenger liner for a cargo frame connected to a bicycle frame, the passenger liner comprising:
a front wall;
a rear wall;
a first foot well having a first exterior side wall, a first interior side wall, and a first bottom wall between the first exterior side wall and the first interior side wall, the first interior side wall having a first end connected to the front wall, the first interior side wall having a second end connected to the rear wall, and wherein the first exterior side wall is removably connected to the first foot well;
a second foot well having a second exterior side wall, a second interior side wall, and a second bottom wall between the second exterior side wall and the second interior side wall, the second interior side wall having a first end connected to the front wall, and the second interior side wall having a second end connected to the rear wall;
a connection member connecting the first interior side wall of the first foot well with the second interior side wall of the second foot well; and,
fasteners to secure the passenger liner to the cargo frame.

19. The passenger liner of claim 18, wherein the second exterior side wall is removably connected to the second foot well.

20. The passenger liner of claim 18, wherein the connection member can be disconnected from at least one of the first interior side wall and the second interior side wall.
